(19) United States
(12) Patent Application Publication
(10) Pub. No.: US 2026/0298352 A1
(43) Pub. Date: Oct. 1, 2026

(54) Improved Gate Valve for Mitigating Grease Loss in a Well Fracturing Environment, and Method of Use Thereof

(71) Applicant: Boss Greaseless Frac Valve LLC, Houston, TX (US)

(72) Inventor: Yongfu Wang, Houston, TX (US)

(21) Appl. No.: 19/095,285

(22) Filed: Mar. 31, 2025

(51) Int. Cl. F16K 3/36; E21B 34/00; F16K 27/04

(52) U.S. Cl. CPC F16K 3/36; E21B 34/00; F16K 27/044

(57) ABSTRACT

This disclosure relates to an improved grease-saving system for fracturing gate valve. The system can comprise a valve body defining a flow passage and a gate cavity, a first valve seat, a gate assembly and a first support plate. The first valve seat is positioned adjacent to a first side of the flow passage, while the gate assembly is within the gate cavity. The gate assembly can comprise a gate having a gate hole movable between a closed position and an open position. In the closed position, the gate forms a seal with the first valve seat, blocking flow through the passage. In the open position, the gate hole aligns with the passage, allowing fluid flow. A first support plate is positioned above the first valve seat within the gate cavity. Additionally, a first plurality of prongs can extend from the second support plate.

### BACKGROUND

This disclosure relates to an improved gate valve for mitigating grease loss in a well fracturing environment, and method of use thereof. Hydraulic fracturing, often referred to as “fracking”, is a method that is widely used in the oil and gas industry to improve the production of wells by creating fractures in subsurface rock formations. Fracturing valves are elements which serve to control the discharge of the fracturing fluid, prevent its back flow, and ensure safe conditions during the process of fracturing. Several types of valves are available and widely employed while fracturing, one among them a slide gate valve. This technique consists of a sliding gate design that enables opening and closing of the valve to control fluid movement. This technique therefore entails two positions; the first is the position where the slide gate is raised to allow fluid passage while the second is the position where the slide gate is lowered thus stopping the fluid passage. While the slide gate opens and closes, there tends to be friction between the parts of the valve which can cause damage to the components over time. To mitigate damage due to friction, grease is applied to components of the slide valve. Gate valves can be effective in shutting the fracturing valve tightly in high pressure fracturing. However, grease applications are typically frequent due to the working environment of hydraulic fracturing. As a result, the usage of such valves can be expensive due to the grease itself as well as the labor involved in application of the grease. As such it would be useful to have an improved gate valve for mitigating grease loss in a well fracturing environment, and method of use thereof.

### SUMMARY

This disclosure relates to an improved grease-saving system for fracturing gate valve. The system can comprise a valve body defining a flow passage and a gate cavity, a first valve seat, a gate assembly and a first support plate. The first valve seat is positioned adjacent to a first side of the flow passage, while the gate assembly is within the gate cavity. The gate assembly can comprise a gate having a gate hole movable between a closed position and an open position. In the closed position, the gate forms a seal with the first valve seat, blocking flow through the passage. In the open position, the gate hole aligns with the passage, allowing fluid flow. A first support plate is positioned above the first valve seat within the gate cavity. Additionally, a first plurality of prongs can extend from the second support plate. The first plurality of prongs is configured to push the first support plate toward a first surface of the gate.

This disclosure also relates to a method of lubricating a fracturing gate valve. The method can comprise the steps connecting a gate valve into a pipeline, wherein the gate valve can comprise a valve body defining a flow passage and a gate cavity, a gate assembly, a valve seat, a support plate, and a plurality of grease fittings. The gate assembly is positioned within the gate cavity. The gate assembly can comprise a gate comprising a gate hole movable between a closed position and an open position. In the closed position, the gate is positioned such that a solid surface of the gate aligns with the valve seats blocking the flow through the passage. In the open position, the gate is positioned such that the gate hole aligns the passage enabling fluid flow through the passage. The valve seat is positioned adjacent to the flow passage to form a sealing engagement with the gate assembly in the closed position. The support plate is positioned above the valve seat within the gate cavity. The support plate is configured to retain lubrication within the valve body and maintain consistent contact between the valve seat and the gate assembly during operation. The plurality of grease fittings can be integrated into the valve body to supply lubrication to the gate assembly, the valve seats, and the support plates within the gate cavity. The method can also comprise the steps of removing the grease fittings from the valve body and lubricating the valve body through port.

### BRIEF DESCRIPTION OF THE DRAWINGS

FIG. 1A illustrates a front view of a fracturing gate valve.

FIG. 1B illustrates a side view thereof.

FIG. 2A illustrates a gate assembly.

FIG. 2B illustrates an exploded view of gate assembly in a closed position between a pair of valve seats and between a pair of support plates.

FIG. 3 illustrates an embodiment of a support plate comprising a plurality of prongs.

FIG. 4A illustrates an isometric view of a body.

FIG. 4B illustrates a sectional view of a body.

FIG. 5A illustrates an isometric view of an upper bonnet attachable at the top surface of a body.

FIG. 5B illustrates a section view of an upper bonnet comprising one or more grease fittings.

FIG. 6A illustrates an isometric view of a lower bonnet attachable at the bottom surface of a body.

FIG. 6B illustrates a section view of a lower bonnet comprising grease fittings.

FIG. 7 illustrates a sectional view showing how a body and bonnets connect.

FIG. 8 illustrates a section view of a fracturing gate valve, showing how the internal components connect.

FIG. 9A illustrates a gate valve in a closed position.

FIG. 9B illustrates a closer view of support plates with a gate valve in a closed position.

FIG. 10A illustrates a gate valve in an open position.

FIG. 10B illustrates a closer view of support plates with a gate valve in an open position.

FIG. 11 illustrates how to lubricate a fracturing gate valve.

FIG. 12 illustrates connecting a lubrication device to grease fittings.

FIG. 13 illustrates putting grease fittings back to a port to cover a valve body.

### DETAILED DESCRIPTION

Described herein is an improved gate valve for mitigating grease loss in a well fracturing environment, and method of use thereof. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers'specific goals (e.g., compliance with system-and business-related constraints), and that these goals will vary from one implementation to another. It will also be appreciated that such development effort might be complex and time-consuming but would nevertheless be a routine undertaking for those of ordinary skill in the field of the appropriate art having the benefit of this disclosure. Accordingly, the claims appended hereto are not intended to be limited by the disclosed embodiments but are to be accorded their widest scope consistent with the principles and features disclosed herein.

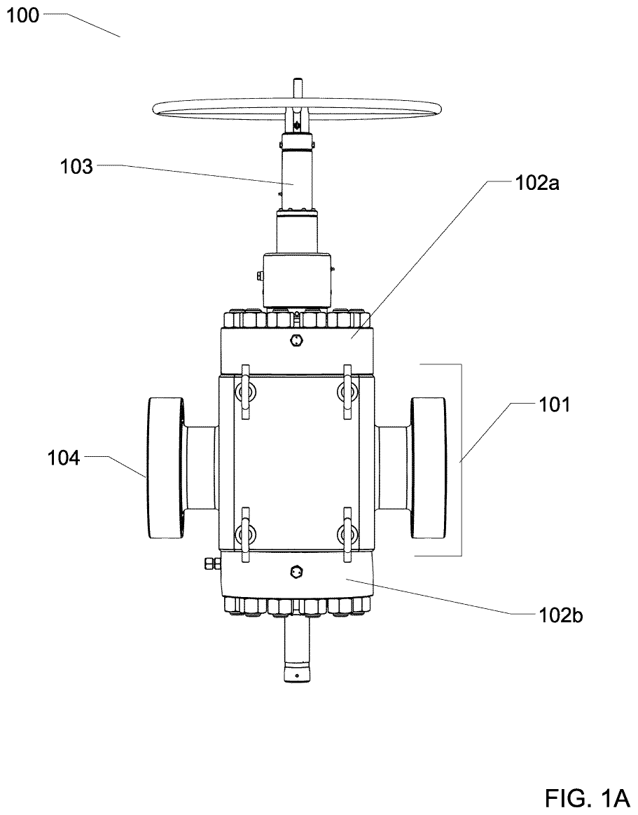

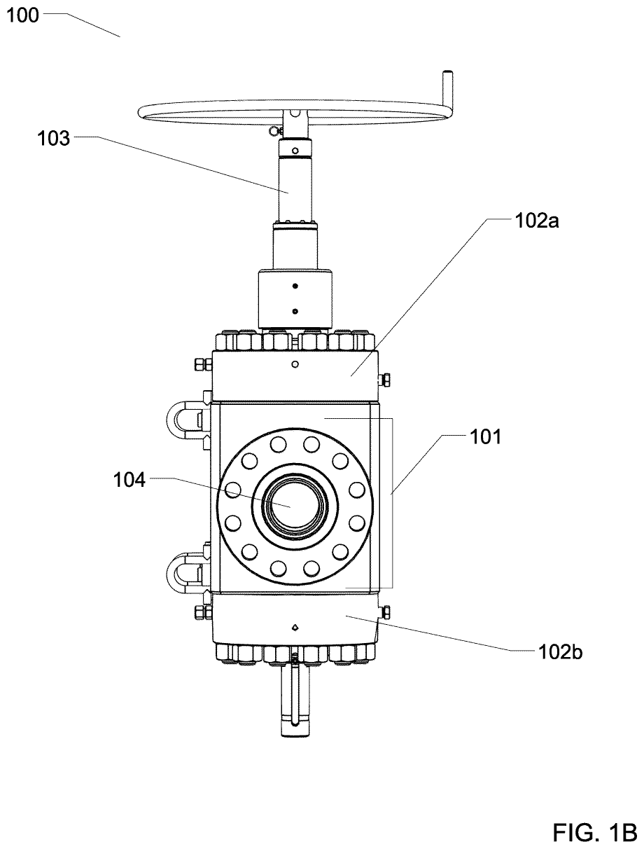

FIG. 1A illustrates a front view of a fracturing gate valve 100 comprising a body 101, at least one bonnet 102, and a gate assembly 103. Body 101 encloses the internal components of gate valve 100 and supports the valve's operation under high pressure and temperature, ensuring fluid containment and flow regulation. Bonnets 102a and 102b are respectively a mountable top and base that each create a solid seal with body 101. In one embodiment, Bonnets 102a and 102b can be made from a variety of metals and alloys known in the art and can be formed using methods such as casting, forging, machining, fabricating, or combinations thereof. In one embodiment, gate valve 100 can comprise an upper bonnet 102a, which covers a top portion of body 101. In another embodiment, gate valve 100 can further comprise a lower bonnet 102b that covers a bottom portion of body 101. Gate assembly 103 can comprise the components of gate valve 100 responsible for controlling the opening and closing of the valve, controlling the flow of materials through a passage 104. Gate assembly 103 intersects with passage 104, allowing material to travel through the valve when gate assembly 103 is in an open position and preventing material to travel through passage 104 when gate assembly 103 is in a closed position.

FIG. 1B illustrates a side view of fracturing gate valve 100. Together, FIGS. 1A-1B shows a substantially symmetrical design of gate valve 100. This configuration allows for the control over bi-directional flow of fluid or materials within the valve, facilitating operation in any direction. Also, in addition, symmetry is helpful in evenly distributing the pressure and wear on gate valve 100, which can be necessary for the durability of the valve in hostile conditions. Also, the symmetrical shape of the design can reduce necessity for maintenance by allowing interchangeable components, thus reducing downtime during servicing.

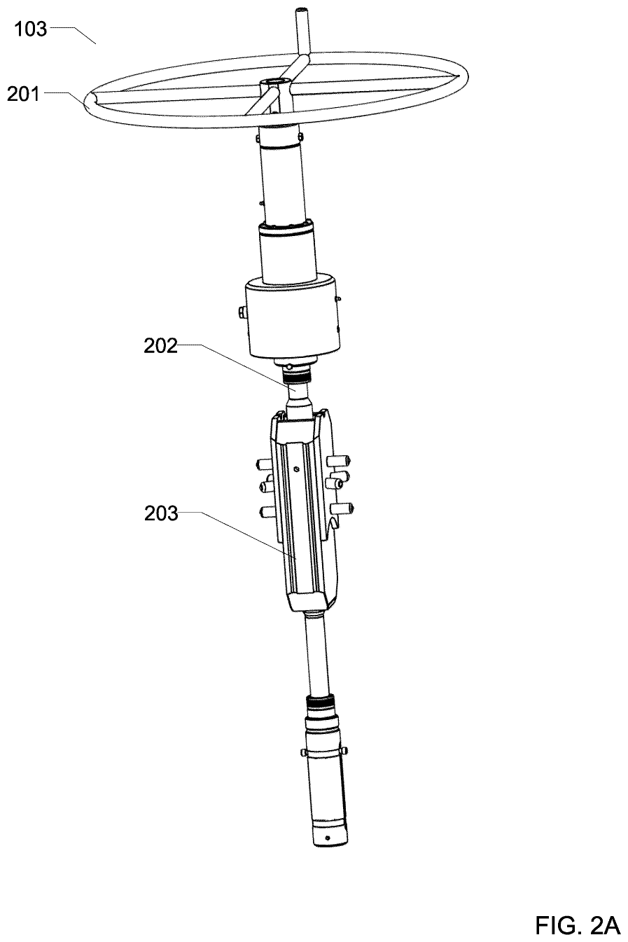

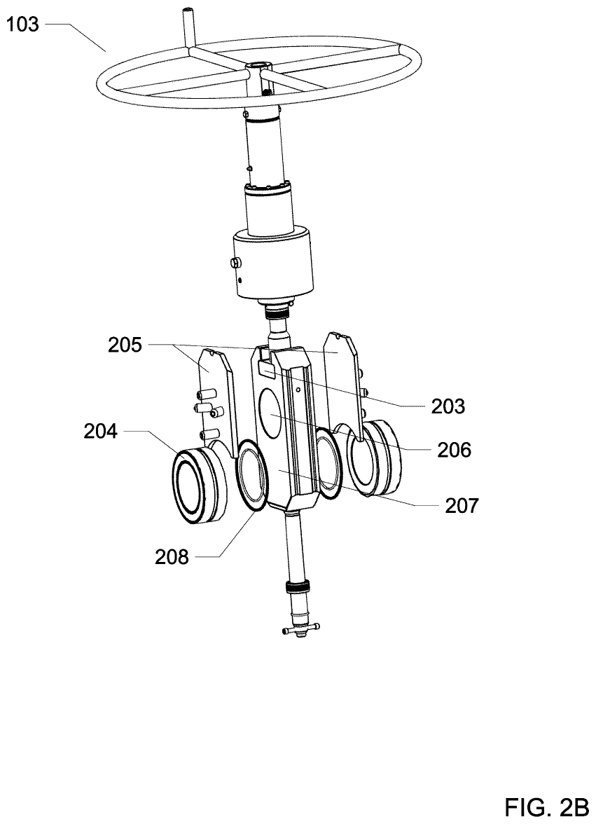

FIG. 2A illustrates gate assembly 103 comprising an actuator 201, a stem 202 and a gate 203. Actuator 201 placed at the top of gate assembly 103, controls the movement of gate 203. Actuator 201 can either be operated manually or automatically using methods such as hydraulic actuation. As shown in FIG. 2A, actuator 201 is a hand wheel that allows operator manual control over the valve position during operations. Stem 202 connects actuator 201 with gate 203 and transmits the force made on actuator 201 to gate 203, allowing gate 203 to move up or down. Furthermore, stem 202 allows a controlled linear motion to move gate 203 ensuring proper alignment and positioning within a body cavity. Gate 203 is placed at the middle portion of gate assembly 103, acts as a barrier between an inlet port and an outlet port of passage 104 that prevents fluid from flowing through gate valve 100.

FIG. 2B illustrates an exploded view of gate assembly 103 in a closed position between a pair of valve seats 204 and a pair of support plates 205. Valve seats 204 each press against gate 203, providing the sealing surface for gate 203. In such configuration, gate 203 can comprise a gate hole 206 at a first portion of the structure and a solid surface 207 at a second portion. In one embodiment, first portion can be above second portion, as shown in FIG. 2B. In another embodiment, first portion can be below second portion. Valve seats 204 work with gate 203 to create a pressure-tight seal when the valve is in the closed position. As such, each valve seat 204 can comprise a seat seal 208 ensuring the proper sealing of passage 104 when gate valve 100 is at a closed position. Valve seat 204 ensures that high-pressure fracturing fluids do not leak through the valve when it is closed, maintaining control over fluid flow and preventing pressure loss. Gate 203 presses against valve seat 204 to form a tight seal, stopping or controlling the flow of fluid, gas, or other material outside of passage 104. Each support plate 205 is positioned above each valve seat 204, configured to ensure that lubrication is properly maintained within gate valve 100. In one embodiment, support plate 205 can be made of corrosion-resistant material such as stainless steel, aluminum and other metals, enhancing the longevity of the valve.

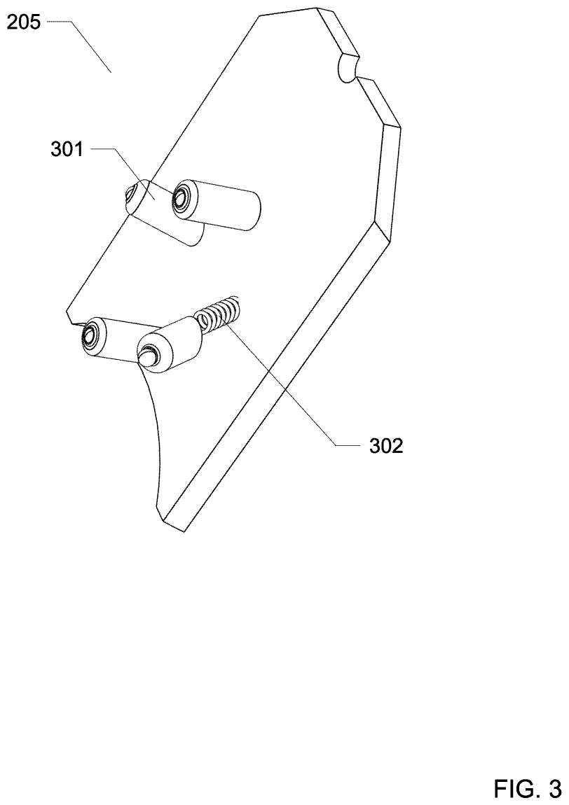

FIG. 3 illustrates an embodiment of support plate 205 comprising a plurality of prongs 301. Each support plate 205 can minimize grease leakage and ensures the lubrication of the valve's internal moving parts. In one embodiment, top corners of support plates 205 are beveled while the bottom edge curves inward, forming a concave arc. This concave arc allows the support plate 205 to rest on top of valve seats 204, while the beveled shape at the top aligns with the upper portion of the gate 203. Prongs 301 can extend outward from the flat side surface of support plates 205. In this embodiment, each prong 301 can comprise a spring 302, enabling prongs 301 to apply adjustable pressure against a surface of gate 203. The spring flexibility can also accommodate slight misalignments or variations in the positioning of gate 203 or valve seat 204, which can enhance the overall performance and reliability of the valve and ensures a consistent sealing engagement. In one embodiment, each support plate 205 can comprise four (4) symmetrical prongs 301 that apply pressure to help retain lubrication.

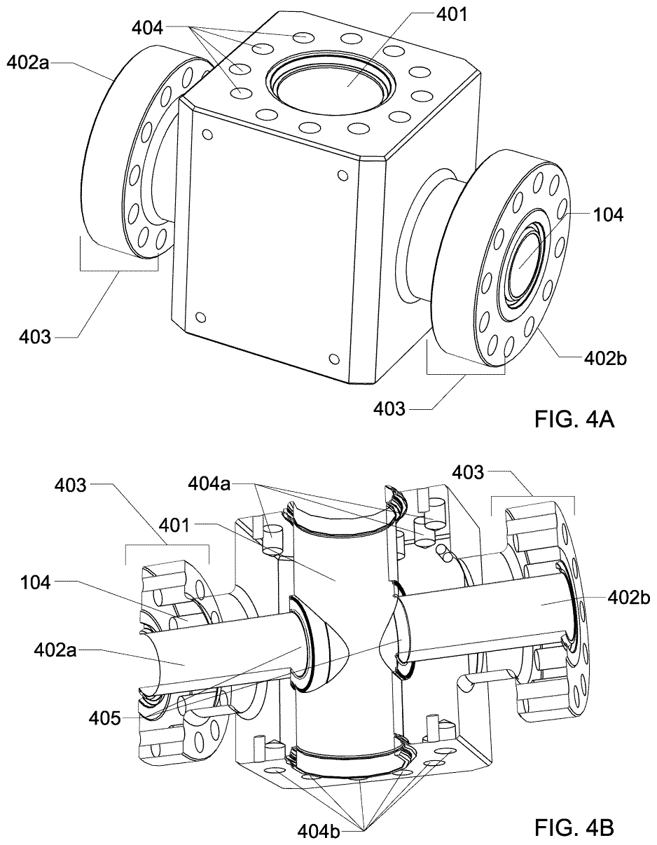

FIG. 4A illustrates an isometric view of valve body 101, the structure of which defines a gate cavity 401 intersecting with passage 104. Passage 104 is a channel within body 101 through which material can flow when fracturing gate valve 100 is in use. Passage 104 can comprise a first chamber 402a and a second chamber 402b (together referred to as chambers 402 or generically as chamber 402). Valve body 101 can comprise a flange 403 on each end of passage 104 to mount fracturing gate valve 100 within a flow control system. Gate assembly 103 can be mounted within gate cavity 401, allowing gate assembly 103 to control flow within passage 104. In one embodiment, the top and/or bottom surfaces of body 101 can each comprise a set of bolt holes 404a distributed around the top and/or bottom surfaces of body 101, first set of bolt holes for mounted bonnets 102a and/or 102b.

FIG. 4B illustrates a sectional view of body 101. The top surface of body 101 can comprise a first set of bolt holes 404a, which, with bolts, can connect upper bonnet 102a at the top surface of body 101, while the bottom surface of body 101 can comprise a second set of bolt holes 404b that, with bolts, can connect lower bonnet 102b at the bottom surface of body 101. Body 101 can further comprise seat recesses 405 positioned at the intersection between gate cavity 401 and passage 104. Each seat recess 405 can be openings made into the walls of passage 104, directly adjacent to where the gate slides through gate cavity 401. This structure can allow the gate of gate assembly 103 to press against the valve seats that are housed within each seat recess 405, to help facilitate the sealing function of gate valve 100.

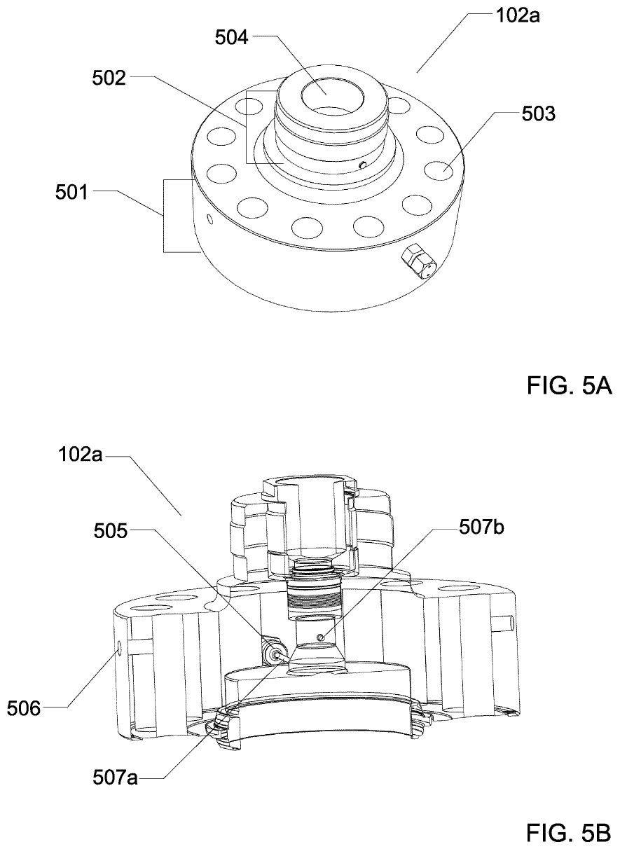

FIG. 5A illustrates an isometric view of upper bonnet 102a attachable at the top surface of body 101. Upper bonnet 102a can comprise a bonnet base 501 and a bonnet neck 502. Upper bonnet 102a can attach to body 101 using any methods known in the art. In one embodiment, bonnet base can comprise a plurality of bonnet base bolt holes 503 that align with the first set of bolt holes 404a on body 101. Fasteners can pass through first set of bolt holes 404a and bonnet base bolt holes 503 to connect upper bonnet 102a to valve body 101. Neck 501 extends upward from the center of upper bonnet 102a, which also comprises a stem cavity 504 that supports gate assembly 103.

FIG. 5B illustrates a section view of upper bonnet 102a comprising one or more grease fittings 505. Each grease fitting 505 covers a port 506, which allows grease to be pumped into the cavity and the internal components of gate valve 100. In one embodiment, grease fittings 505 can comprise a plurality of grease distribution channels 507 integrated into valve body 101, configured to distribute lubricant to internal components of gate valve. Grease distribution channels 507 allow lubricant to be directed to specific areas or components of the gate valve that require lubrication, providing targeted maintenance and ensuring optimal performance of the valve over time. For example, a first channel 507a directs lubricant from grease fittings 505 to gate cavity 401. Another example, a second channel 507b directs lubricant from another grease fittings to stem 502.

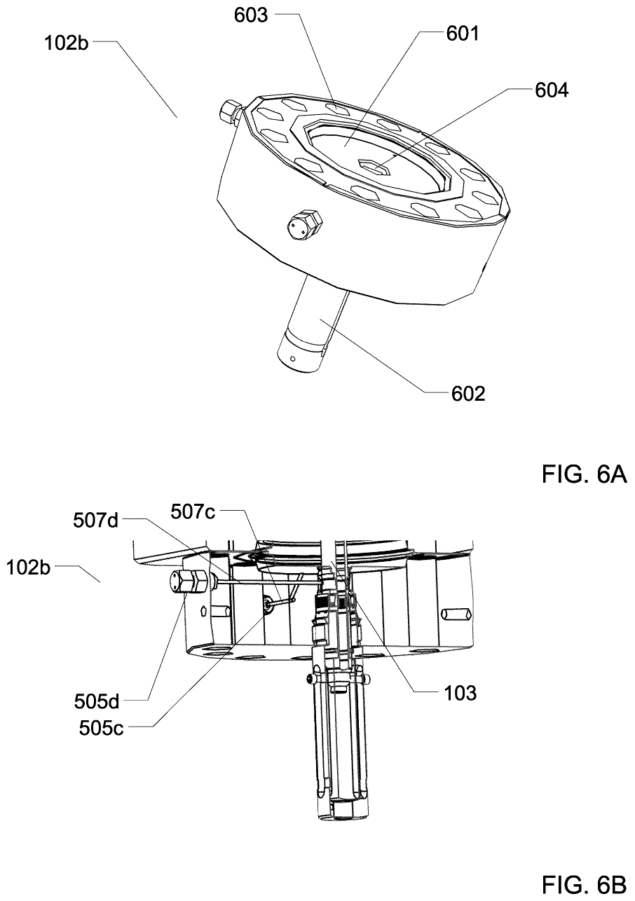

FIG. 6A illustrates an isometric view of lower bonnet 102b attachable at the bottom surface of body 101. In one embodiment, lower bonnet 102b can comprise a gasket seat 601, a stem protector 602, and a plurality of bottom-bonnet bolt holes 603. Bottom-bonnet bolt holes 603 can align with second set of bolt holes 404b on body 101. Gasket seat 601 can be a recessed portion at the center of lower bonnet 102b. Fasteners can pass through second set of bolt holes 404b and base bonnet bolt holes 603 to connect lower bonnet 102b to valve body 101. Gasket seat 601 can hold a gasket or a seal to ensure leak-proof between lower bonnet 102b and body 101. Stem protector 602 is configured to provide additional support to the gate assembly, ensuring alignment and preventing misalignment during movement of gate 203 between open position and closed position. The center of lower bonnet 102b can comprise a bottom stem cavity 604, an opening that receives a bottom portion of gate assembly 103.

FIG. 6B illustrates a section view of lower bonnet 102b comprising grease fittings 505. Grease fittings 505 can be strategically positioned to facilitate the injection of lubricant or grease into gate cavity 401, ensuring that components of gate valve 100 remains properly lubricated during operation. In one embodiment, each grease fitting 505 can connect to grease distribution channel 507.

Lower bonnet 102b can comprise a third channel 507c and a fourth channel 507d, each with distinct function. Third channel 507c directs lubricant from grease fittings 505c to gasket seat 601, ensuring the gasket between lower bonnet 102b and valve body 101 is well-lubricated. This reduces wear on the gasket, extends its lifespan, and maintains a tight seal to prevent leaks.

Fourth channel 507d delivers lubricant from second grease fittings 505d to stem 202 of gate assembly 103. This lubrication minimizes friction during the gate's movement, enhancing the valve's durability and performance. Additionally, as the gate moves, it helps distribute the lubricant across internal components, ensuring smooth and consistent operation throughout the valve's lifecycle.

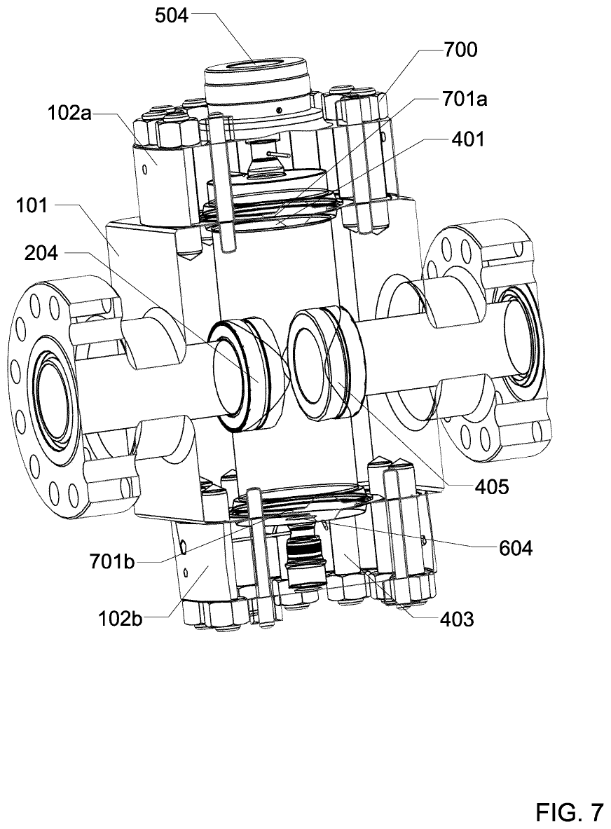

FIG. 7 illustrates a sectional view showing how body 101 and bonnets 102 connect. In this configuration, bonnet base bolt holes 503 align with first bolt holes 404a, while bottom bonnet bolt holes 603 align with second bolt holes 404b. This alignment ensures that upper bonnet 102a can be securely attached to the top surface of body 101, and lower bonnet 102b to the bottom surface of body 101, using a plurality of bolts 700 for a secure and leak-proof connection. A first bonnet seal 701a is placed between upper bonnet 102a and the top surface of body 101, while a second bonnet seal 701b is placed between lower bonnet 102b and the bottom surface of body 101, providing extra sealing to prevent fluid or pressure leaks during operation.

Additionally, the bottom portion of gate assembly 103 can be mounted within the stem cavity 504 of upper bonnet 102a, the gate cavity 401, and the bottom stem cavity 604 of lower bonnet 102b. In this configuration, each valve seat 204 rests in its respective seat recess 405 on body 101.

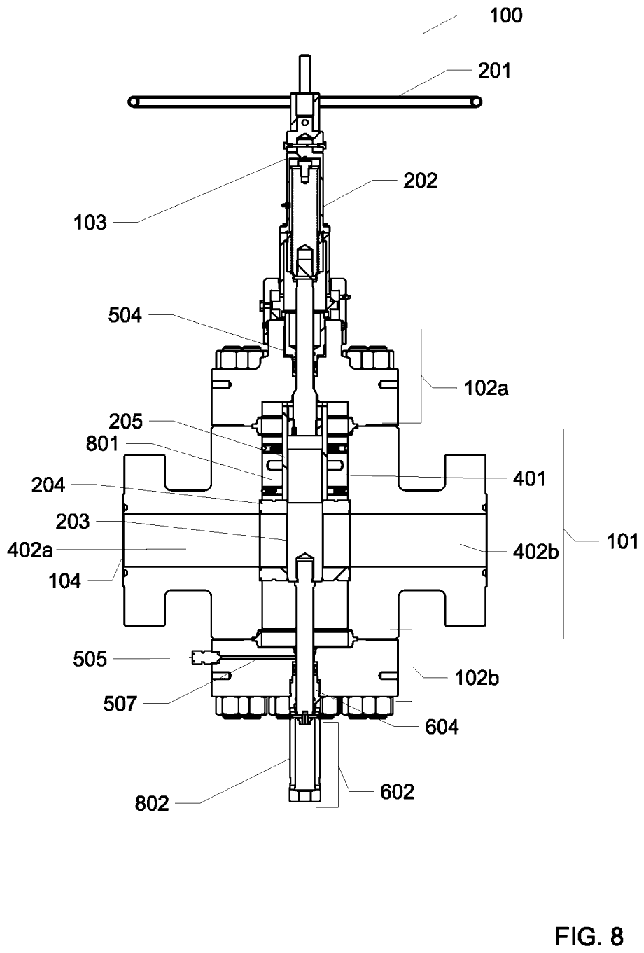

FIG. 8 illustrates a section view fracturing gate valve 100, showing how the internal components connect. Gate assembly 103 is centrally positioned within gate cavity 401, allowing it to move vertically to control the flow of fluid through passage 104. The upper portion of gate assembly 103 fits into stem cavity 504 of upper bonnet 102a, while the lower portion fits into bottom stem cavity 604 of lower bonnet 102b, providing stability and alignment during operation. In such structure, actuator 201 is the accessible portion of gate assembly 103 that operates the opening and closing gate valve 100.

Stem 202 comes into contact with support plates 205 and valve seats 204, which is further shown and discussed below. Prongs 301 on support plates 205 creates a plurality of gaps 801 between the inner surface of gate cavity 401 and stem 502. The gaps 801 around prongs 301 of support plate 205 are configured to trap and evenly distribute lubrication within the gate cavity. Additionally, the spring-loaded prongs 301 facilitate lubrication flow within gaps 801, enhancing the lubrication of the valve components during operation. Valve seats 204 are seated within seat recesses 405 on either side of gate 203, creating a tight seal with gate 203 to prevent fluid leakage when the valve is closed. A void 802 at the bottom portion of gate cavity 401 allows gate 203 to move downward, placing the valve at an open position. Support plates 205, located above valve seats 204, provide structural reinforcement and maintains lubrication within the valve. Support plates 205 can also ensure that valve seats 204 maintain proper contact with gate 203 during high-pressure fracturing operations. Grease fittings 505 supply lubrication through channels 507 to critical areas, such as the gate and stem, ensuring smooth movement and reducing wear. This integrated design ensures components of gate valve 100 work together efficiently, delivering reliable sealing and operation under demanding fracturing conditions.

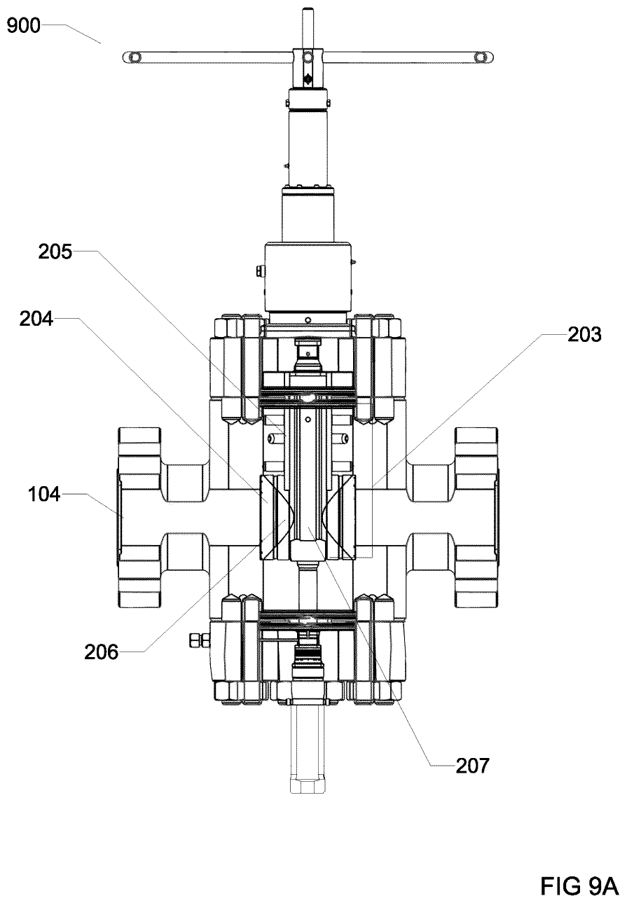

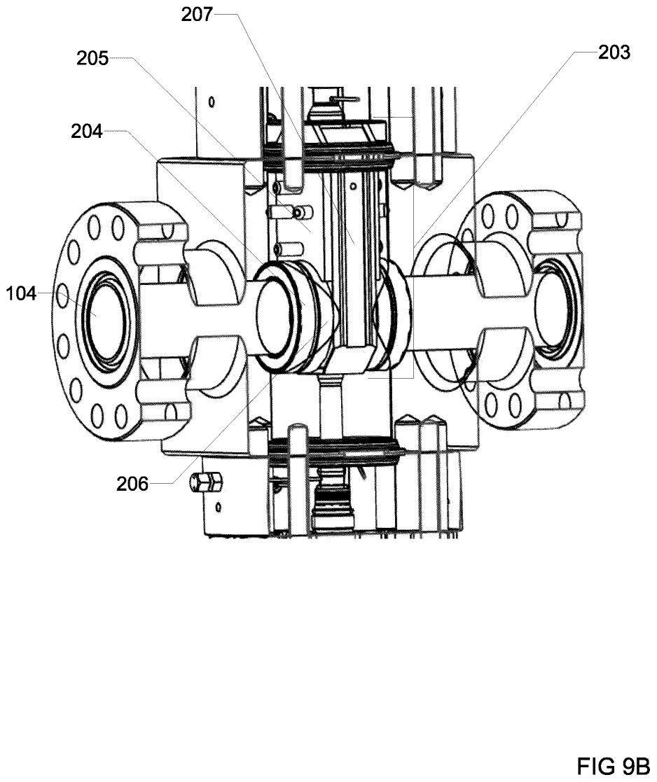

FIG. 9A illustrates gate valve 100 in a closed position 900. In this configuration, gate is fully raised, wherein solid surface 207 of gate 203 aligns with valve seats 204 within gate cavity 401, effectively blocking the flow through passage 104. Seat seal 208 can also help to tight seal between gate 203 and valve seats 204 and prevents fluid from passing through the valve, ensuring a leak-proof closure. Support plates 205 help maintain proper alignment and pressure on valve seats 204, further enhancing the sealing integrity of gate valve 100 when in the closed position. This closed position is crucial for isolating sections of the fluid flow during fracturing operations, providing safety and control over fluid pressure.

FIG. 9B illustrates a closer view of support plates 205 in closed position 900. In one embodiment, the lower portion of support plates 205 can attach to the upper portion of the corresponding valve seat 204. In a resting or closed position 900, each support plate 205 sits on top of the valve seat 204, effectively blocking gate hole 206 and creating a seal that prevents any fluid passage.

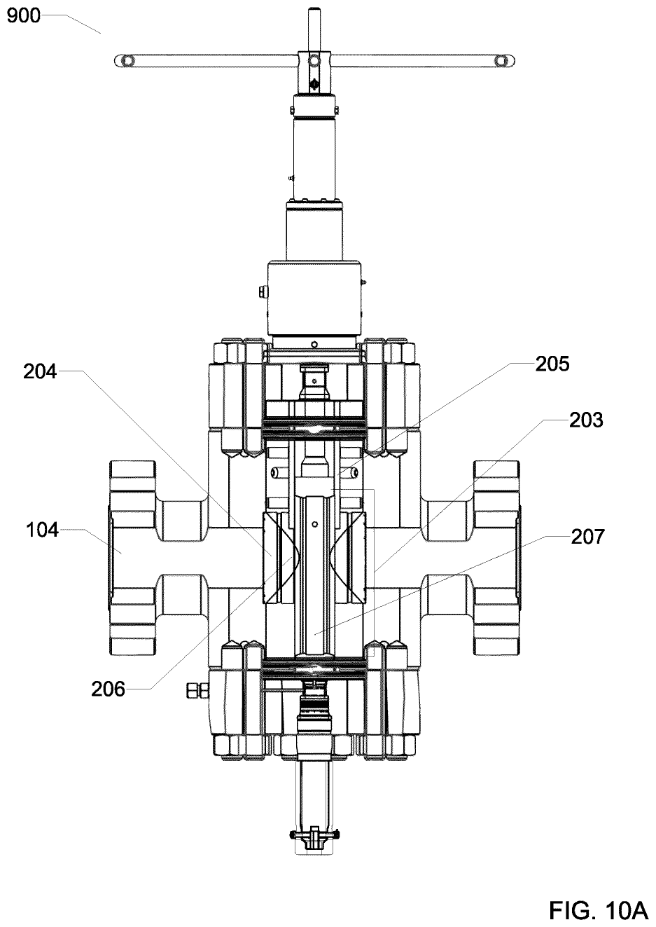

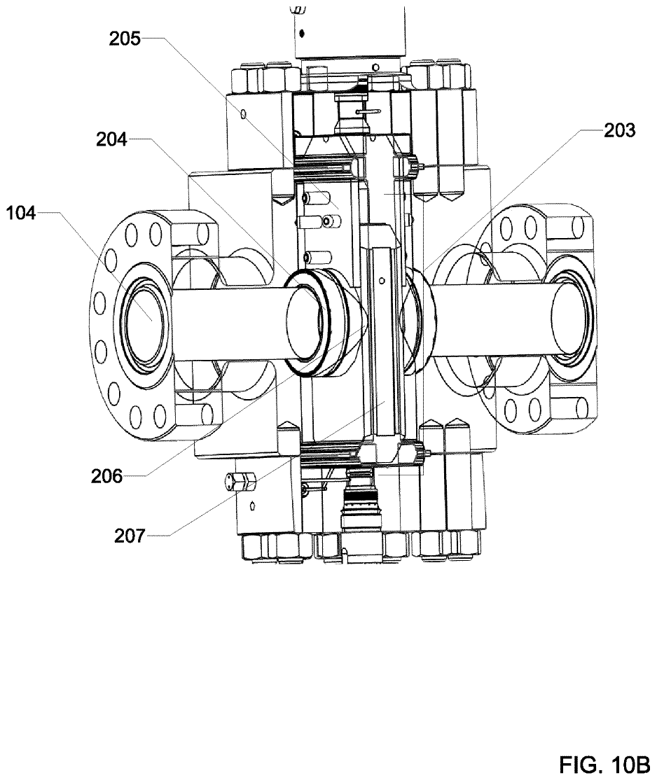

FIG. 10A illustrates gate valve 100 in an open position 1000. In this configuration, gate 203 is fully lowered, allowing gate hole 206 to align with valve seats 204 and passage 104, enabling fluid to flow freely through the valve. As gate 203 descends into void 802 at the bottom of gate cavity 401, the previously blocked flow path is opened. Support plates 205 help maintain the alignment of valve seats 204 with the gate hole 206, ensuring a smooth transition between open and closed positions. The precision of these components is critical for regulating flow during fracturing operations, providing reliability and control over high-pressure fluid movement.

FIG. 10B illustrates a closer view of support plates 205 in an open position 1000. When gate 203 moves to an open position, the gate is lowered, which aligns gate hole 206 with passage 104 of chambers 402. Support plates 205 are equipped with prongs 301, which enable the plates to be positioned within the gate cavity 401. Prongs 301, which extends from support plates 205 are configured to push support plates toward the surface of gate 203. These prongs 301 create gap 801 within the gate cavity, allowing lubricant to flow freely around prongs 301 and along the valve seat surface. This configuration helps to ensure continuous lubrication of the valve components, reducing friction during operation and enhancing the valve's longevity. The prong structure also permits slight flexibility, accommodating minor misalignments between the gate and valve seats, which contributes to a reliable and consistent sealing engagement.

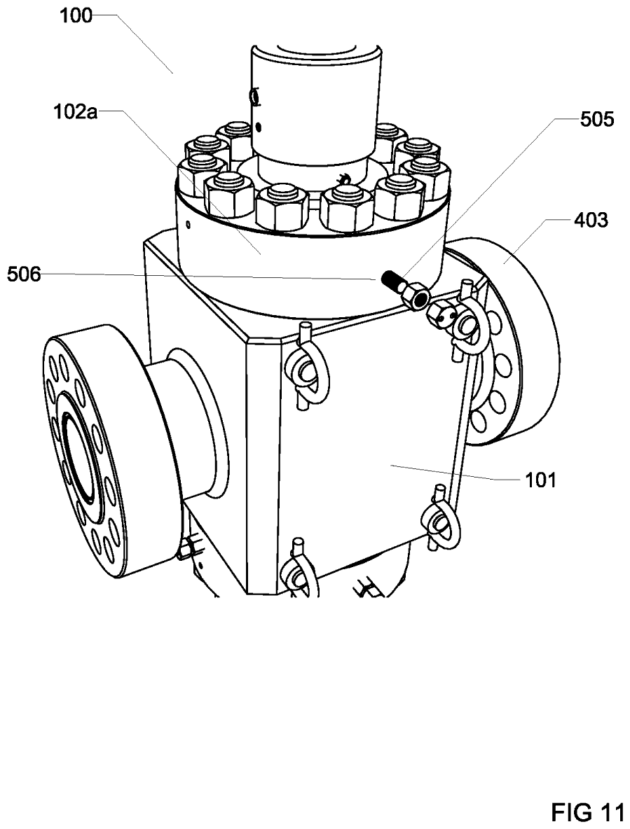

FIG. 11 illustrate how to lubricate a fracturing gate valve 100. Initially, gate valve 100 is installed and connected to a pipeline by securing valve body 101 using flanges 403. The installation process begins with aligning the valve body 101 with the pipeline and securing it using bolts through the flanges, ensuring a stable connection. Once gate valve 100 is properly installed, the lubrication process can begin by removing grease fitting 505 from bonnets 102, exposing port 506.

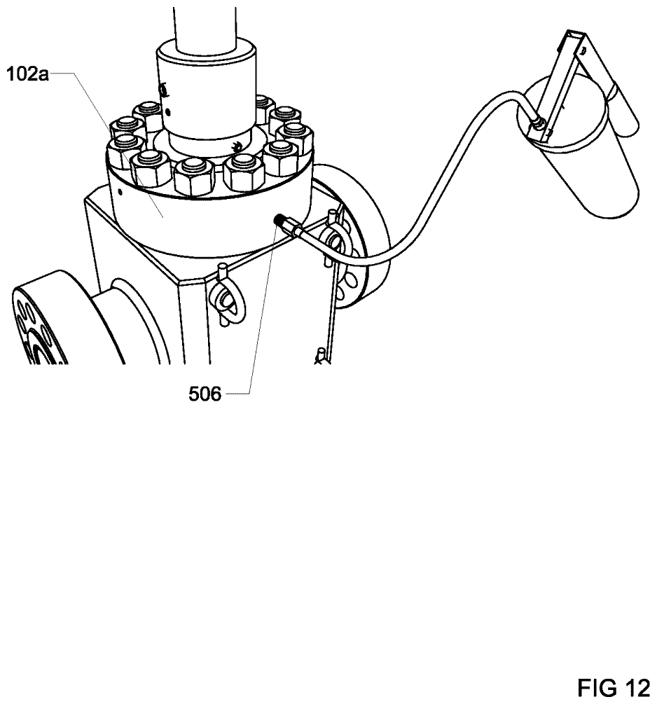

FIG. 12 illustrates connecting a lubrication device to grease fittings 505. Lubrication device or a grease gun can be inserted into exposed port 506 of grease fittings 505. These fittings can allow direct injection of lubricant into the valve's internal components, including the gate assembly 103, valve seat 204, and support plate 205. The operator then pumps grease into the valve body 100 via the grease fittings 505. The grease distribution channels 507 within the valve body 101 guide the lubricant to the necessary areas, including the gap 801 on the support plate 205 and the prongs 301. This ensures that the gate assembly 103 and valve seat 204 are consistently lubricated during both open and closed operations, minimizing friction and preventing wear.

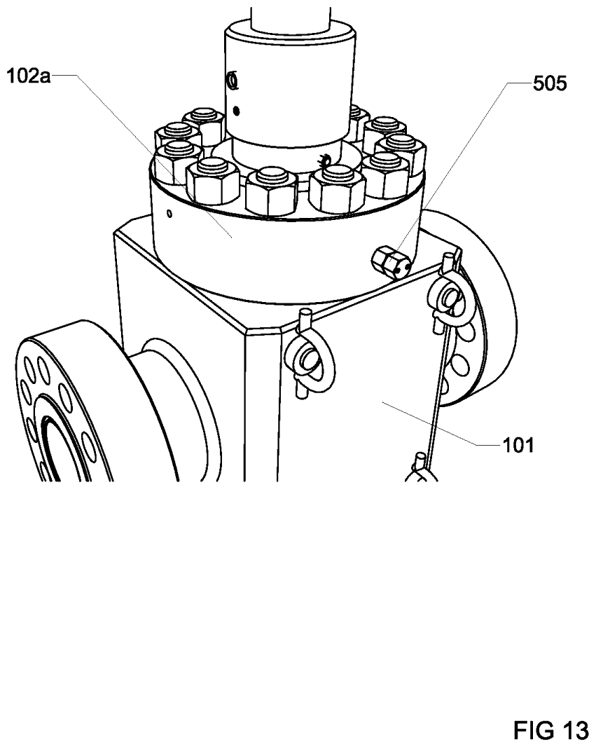

FIG. 13 illustrates putting grease fittings 505 back to port 506 covering valve body 101. After lubrication is completed, the operator checks for proper grease distribution by inspecting the movement of the gate assembly and ensuring that no lubricant leakage occurs. Regular lubrication, following this process, helps maintain optimal valve performance and extends the life of the internal components.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. An improved grease-saving system for fracturing gate valve comprising a valve body defining a flow passage and a gate cavity;
a first valve seat positioned adjacent to a first side of said flow passage;
a gate assembly positioned within said gate cavity, said gate assembly comprising a gate having a gate hole movable between
a closed position wherein a solid surface of said gate forms a seal with said first valve seat blocking the flow through said passage; and
an open position wherein said gate hole aligns said passage enabling fluid flow through said passage;
a first support plate positioned above said first valve seat within said gate cavity; and
a first plurality of prongs extending from said second support plate, said first plurality of prongs configured to push said first support plate toward a first surface of said gate.

2. The system of claim 1 further comprising
a second valve seat positioned adjacent to a second side of said flow passage that forms a sealing engagement with said gate assembly in said closed position;
a second support plate positioned above said valve seat within said gate cavity; and
a second plurality of prongs extending from said second support plate, said second plurality of prongs configured to push said second support plate toward a second surface of said gate.

3. The system of claim 1, further comprising a first set of bolt holes distributed around the top surface of said valve body, wherein said first set of bolt holes is configured to align with a plurality of upper bonnet holes on an upper bonnet, said first set of bolt holes and said upper bonnet holes attachable using a plurality of bolts allowing said upper bonnet to attach to said valve body.

4. The system of claim 3, further comprising a second set of bolt holes distributed around the bottom surface of said valve body, wherein said second set of bolt holes is configured to align with a plurality of lower bonnet holes on a lower bonnet, said second set of bolt holes and said lower bonnet holes attachable using said plurality of bolts to secure said lower bonnet to the valve body.

5. The system of claim 4, wherein said lower bonnet comprises a stem protector configured to provide additional support to the gate assembly, ensuring alignment and preventing misalignment during movement between said open position and said closed positions.

6. The system of claim 5 further comprising a first bonnet seal placed between said upper bonnet and the top surface of said body, and a second bonnet seal placed between said lower bonnet and the bottom surface of said body, wherein said bonnet seals configured to prevent fluid leakage between said bonnets and said body during operation.

7. The system of claim 1 wherein said first support plate further comprises a plurality of grease fittings integrated into said valve body to supply lubrication to said gate assembly, said valve seats, and said support plates within said gate cavity.

8. The system of claim 1 wherein each prong of said first set of prongs of said first support plate comprises a spring, said springs applying pressure against said first side of said gate.

9. The system of claim 8, wherein said prongs are symmetrically distributed around said support plate such that such support plate applies uniform pressure against said first side of said gate.

10. The system of claim 1, wherein said grease fittings comprise a grease distribution channel integrated into said valve body, configured to distribute lubricant within said gate cavity.

11. A method of use for a fracturing gate valve comprising the steps of controlling flow within a pipeline using a gate valve, said gate valve comprising
a valve body defining a flow passage and a gate cavity;
a gate assembly positioned within said gate cavity, said gate assembly comprising
a gate comprising a gate hole movable between
a closed position wherein said gate is positioned such that a solid surface of said gate aligns with said valve seats blocking the flow through said passage; and
an open position wherein said gate is positioned such that said gate hole aligns said passage enabling fluid flow through said passage;
a valve seat positioned adjacent to said flow passage to form a sealing engagement with said gate assembly in said closed position;
a support plate positioned above said valve seat within said gate cavity, said support plate configured to retain lubrication within said valve body and maintain consistent contact between said valve seat and said gate assembly during operation; and
a plurality of grease fittings integrated into said valve body to supply lubrication to said gate assembly, said valve seats, and said support plates within said gate cavity.

12. The method of claim 1, wherein said grease fittings each comprise a grease distribution channel integrated into said valve body, configured to distribute lubricant within said gate cavity.

13. The method of claim 12 further comprising the steps
removing grease fittings from said valve body and
lubricating said valve body through port.

14. The method of claim 11 further comprising the step of actuating said gate assembly through an actuator, said actuator placed at the top portion of said gate assembly.

15. The method of claim 14 wherein said actuator is a hydraulic actuator.

16. The method of claim 11 wherein the gate valve further comprises
a second valve seat positioned adjacent to a second side of said flow passage that forms a sealing engagement with said gate assembly in said closed position;
a second support plate positioned above said valve seat within said gate cavity; and
a second plurality of prongs extending from said second support plate, said second plurality of prongs configured to push said second support plate toward a second surface of said gate.

17. The method of claim 11 wherein said first support plate further comprising a first plurality of prongs creating a gap configured to trap and distribute lubrication across said first side of said gate.

18. The method of claim 17 wherein each prong of said first plurality of prongs comprises a spring allowing said prongs to apply pressure against a first side of said gate

19. The method of claim 17, wherein said prongs are symmetrically distributed around said first support plate.
